(19) United States
(12) Patent Application Publication
(10) Pub. No.: US 2025/0074089 A1
(43) Pub. Date: Mar. 6, 2025

(54) PRINTING APPARATUS

(71) Applicant: CANON KABUSHIKI KAISHA, Tokyo (JP)

(72) Inventors: TAKEHIRO NAKATA, Tokyo (JP); YASUHITO TSUBAKIMOTO, Tokyo (JP); AKIRA NAKASHIMA, Kanagawa (JP); MASAYUKI IMANO, Kanagawa (JP); HIROSHI YOSHINO, Kanagawa (JP); TORU YADA, Kanagawa (JP); ATSUSHI IKEDA, Kanagawa (JP); KOTARO IZUMIYA, Kanagawa (JP)

(21) Appl. No.: 18/804,417

(22) Filed: Aug. 14, 2024

(30) Foreign Application Priority Data
Aug. 28, 2023 (JP) 2023-137875

(51) Int. Cl. B41J 25/304; B41J 2/175; B41J 29/13

(52) U.S. Cl. CPC B41J 25/304; B41J 2/1728; B41J 2/17596; B41J 29/13

(57) ABSTRACT

A technology that can improve usability while suppressing a reduction in workability in using each member is to be provided. A printing apparatus includes; a print head configured to perform printing by ejecting ink on a print medium; a frame member configured to accommodate the print head; an opening/closing member configured to pivotally move with respect to the frame member; a first storing unit configured to store ink; a first cover configured to cover the first storing unit and to be installed adjacent to side of the opening/closing member in a first direction; and a movable member configured to move with respect to the frame member and to be installed adjacent to the side of the opening/closing member in the first direction, wherein a part of the movable member and a part of the first cover form an upper surface of the printing apparatus together with the opening/closing member.

### BACKGROUND OF THE INVENTION

### Field of the Invention

The present invention relates to a printing apparatus that performs printing on a print medium.

### Description of the Related Art

Generally, in a printing apparatus such as a multifunction peripheral equipped with a printing function and a reading function, the user is required to execute various jobs, such as injecting ink, setting the document to be read, inputting to an operation part, setting print media, handling jams, and processing waste ink, for example.

Japanese Patent Laid-Open No. 2007-168134 discloses a technology in which an ink tank and an operation part, which are frequently used in execution of the corresponding jobs, are placed on the front surface of the apparatus to improve usability.

However, in the technology disclosed in Japanese Patent Laid-Open No. 2007-168134, the ink tank and the operation part are consolidated on the front right side of the apparatus. Therefore, there has been a need for multiple members to be placed in a small space, which may impose restrictions on the shape and size of the configuration of each member and reduce workability in using each member.

### SUMMARY OF THE INVENTION

The present invention has been made in view of the above-mentioned issues and provides a technology that can improve usability while suppressing a reduction in workability in using each member.

A printing apparatus includes; a print head configured to perform printing by ejecting ink on a print medium, a frame member configured to accommodate the print head; an opening/closing member configured to pivotally move with respect to the frame member; a first storing unit configured to store ink; a first cover configured to cover the first storing unit and to be installed adjacent to side of the opening/closing member in a first direction; and a movable member configured to move with respect to the frame member and to be installed adjacent to the side of the opening/closing member in the first direction, wherein a part of the movable member and a part of the first cover form an upper surface of the printing apparatus together with the opening/closing member.

According to the present invention, it is possible to improve usability while suppressing a reduction in workability in using each member.

Further features of the present invention will become apparent from the following description of exemplary embodiments with reference to the attached drawings.

### BRIEF DESCRIPTION OF THE DRAWINGS

FIG. 1A and FIG. 1B are perspective configuration diagrams of a printing apparatus;

FIG. 2A and FIG. 2B are a front view and plan view of the printing apparatus;

FIG. 3 is a schematic configuration diagram of a printing part;

FIG. 4 is a diagram illustrating the state of some movable members after operation;

FIG. 5A and FIG. 5B are diagrams for explaining the configuration of an operation part;

FIG. 6A to FIG. 6C are diagrams for explaining the attachment and detachment of the first cover;

FIG. 7A to FIG. 7D are diagrams for explaining a lock part in the second cover;

FIG. 8 is a diagram illustrating an accommodation part of a waste ink tank;

FIG. 9A to FIG. 9C are diagrams illustrating the relationship between the first cover and a reading part in the closed position;

FIG. 10 is a diagram illustrating the relationship between the movement area of the operation part and the working area for an ink tank;

FIG. 11 is a diagram illustrating the positional relationship between the second cover and the reading part in the closed position;

FIG. 12 is a perspective view of the printing apparatus with the reading part in the open position;

FIG. 13A to FIG. 13D are diagrams for explaining the connection between a damper unit and a frame member;

FIG. 14A and FIG. 14B are perspective views of the damper unit,

FIG. 15A to FIG. 15C are configuration diagrams of the damper unit;

FIG. 16 is a block diagram illustrating the configuration of a control system of the printing apparatus; and

FIG. 17A and FIG. 17B are diagrams for explaining modification examples of the frame member.

### DESCRIPTION OF THE EMBODIMENTS

Hereinafter, with reference to the accompanying drawings, a detailed explanation is given of an example of embodiments of the printing apparatus. Note that the following embodiments are not intended to limit the present invention, and every combination of the characteristics explained in the present embodiments is not necessarily essential to the solution provided in the present invention. Further, the positions, shapes, etc., of the constituent elements described in the embodiments are merely examples and are not intended to limit the range of this invention to the examples.

In the explanation of the present embodiments, a multifunction peripheral equipped with a printing function for ejecting ink as a printing agent onto a print medium using an inkjet system to perform printing and a reading function for reading a document placed on a platen glass is taken as an example of the printing apparatus. Note that the printing system is not limited to the inkjet system, and may be, for example, electrophotographic system. Printing agents that can be ejected by the printing apparatus according to the present embodiments are not limited to ink, and include various known printing agents used for printing, such as processing liquids for applying a predetermined treatment to the ejected ink.

In the present embodiments, “printing” not only indicates cases of forming meaningful information such as characters and figures. That is, being meaningful or meaningless does not matter. Further, whether or not being elicited in such a manner that a human can visually perceive does not matter, and the cases of forming an image, a design, a pattern, or the like on a print medium in a broad sense or processing a medium are included. In the present embodiments, the “print medium” includes not only paper used in a general printing apparatus but also a cloth, plastic film, metal plate, glass, resin, wood, leather, and the like that can accept the printing agent to be used.

In the present specification, viewing from a position facing the side to which print media are discharged after printing, the direction from the left side toward the right side of the apparatus is explained as the X direction, the direction from the rear side (the back side) toward the near side (the front side) is explained as the Y direction, and the direction from the lower side toward the upper side is explained as the Z direction. In this way, the X direction, Y direction, and Z direction are directions from one side toward the other side, and are directions perpendicular to one another. In the present specification, each direction is represented with a “+(plus)” in a case of going from the one side toward the other side, and with a “−(minus)” in a case of going from the other side toward the one side, as appropriate.

### Configuration of the Printing Apparatus

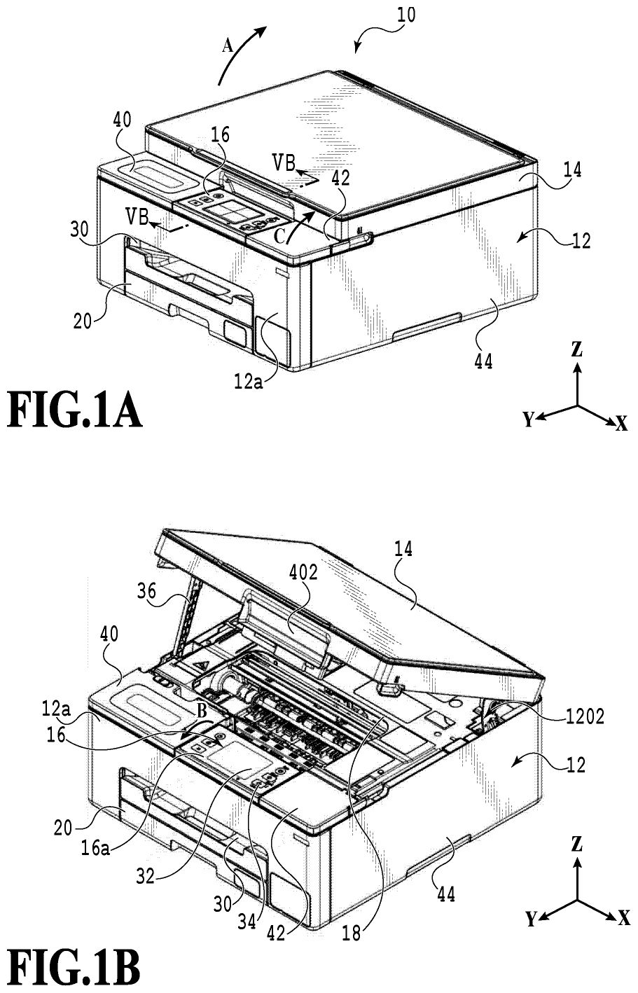

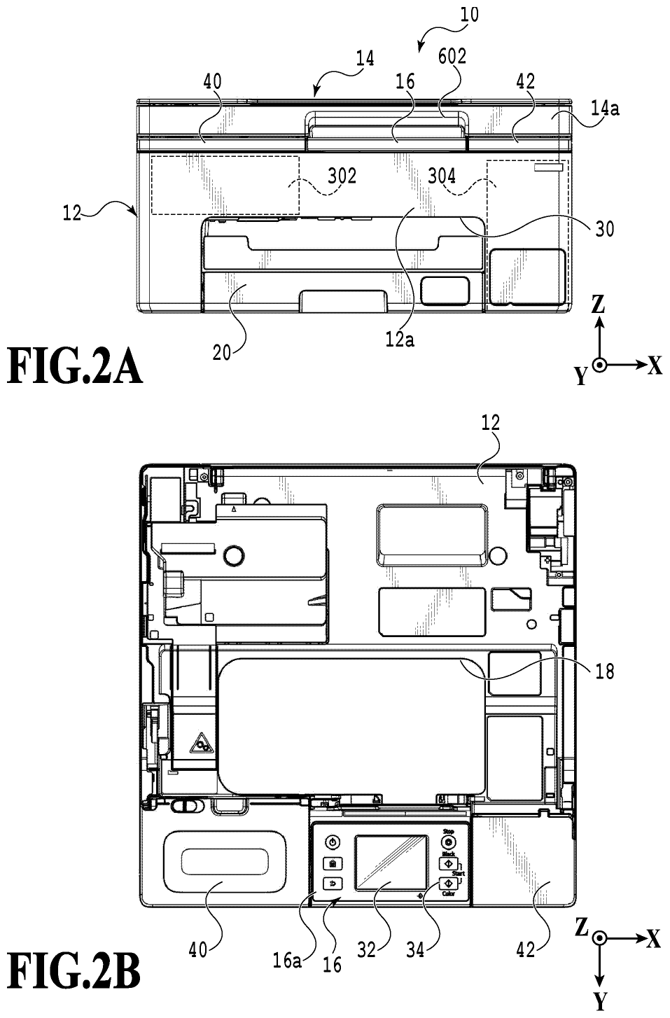

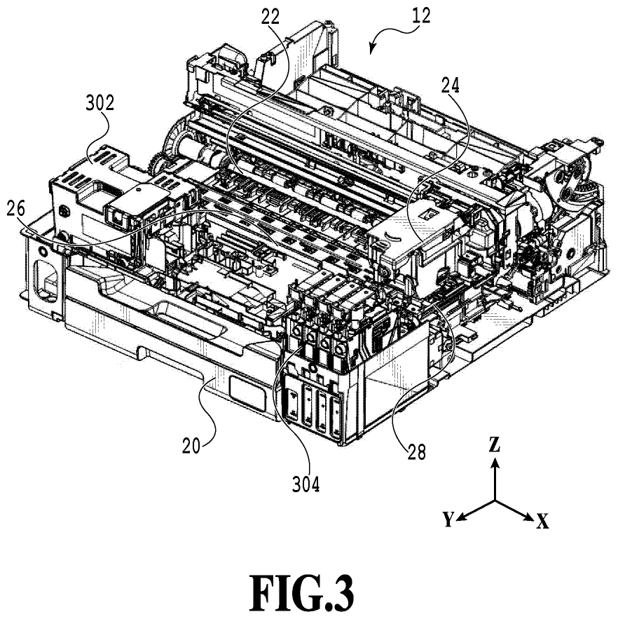

FIG. 1A and FIG. 1B are perspective configuration diagrams of the printing apparatus, with FIG. 1A illustrating the reading part in the closed state and FIG. 1B illustrating the reading part in the open state. FIG. 2A is a front view of the printing apparatus, and FIG. 2B is a plan view of the printing part. Note that, for ease of understanding, the internal configuration of the printing part inside the opened part is omitted in FIG. 2B. FIG. 3 is a perspective view of the internal structure of the printing part.

The printing apparatus 10 illustrated in FIG. 1A and FIG. 1B includes the printing part 12 capable of performing printing on a print medium, the reading part 14 capable of reading a placed document, and the operation part 16 capable of operating the printing apparatus 10. The reading part 14 and the operation part 16 are installed on the upper surface of the printing part 12. The reading part 14 is located on the back side of the upper surface of the printing part 12, and the operation part 16 is located on the front side of the aforementioned upper surface. As described in detail later, the reading part 14 is installed so as to be openable/closable on the upper surface of the printing part 12, and, in the open state, the opened part 18 formed in the aforementioned upper surface is exposed to the outside (see FIG. 1B and FIG. 2B). Accordingly, the user is allowed to access the interior of the printing part 12 through the opened part 18. Further, in the closed state, the reading part 14 closes the opened part 18 (see FIG. 1A). In the present embodiment, the reading part 14 forms the upper surface of the printing apparatus 10 and functions as an opening/closing member that is openable/closable on the upper surface of the printing part 12.

The printing part 12 includes the accommodation part 20 that accommodates print media and the conveyance part 22 that conveys the print medium fed by a feeding part (not illustrated in the drawings) to the printing position (see FIG. 3). Further, the printing part 12 includes the print head 24 that performs printing by ejecting ink onto the print medium conveyed to the printing position by the conveyance part 22. Furthermore, the printing part 12 includes the discharge part 26 that discharges the print medium on which printing has been performed by the print head 24, and the recovery unit 28 that maintains and recovers good ink ejection characteristics from the print head 24.

The accommodation part 20 loads and accommodates print media. The topmost sheet of the print media accommodated in the accommodation part 20 is picked up and transferred to the back side by the feeding part, and then, after a U-turn through a feeding path (not illustrated in the drawings), the sheet is transferred from the back side toward the front side and fed to the conveyance part 22. The printing apparatus 10 may be configured with the ability of feeding print media from the back side of the printing apparatus 10, or may be configured with the ability of feeding print media both from the accommodation part 20 and from the back side of the printing apparatus 10. Note that, since various known technologies can be used for the configurations capable of feeding print media from the back side of the printing apparatus 10, a detailed explanation thereof is omitted. The conveyance part 22 conveys the print medium fed by the feeding part in the +Y direction to the printing position where printing can be performed by the print head 24. In the present embodiment, the accommodation part 20 functions as a disposing part for placing the print media to be fed from the front surface 12a side of the printing apparatus 10 to the printing position where printing is performed by the print head 24.

The print head 24 is configured with the ability of reciprocating in the X direction, and, on the surface facing the print medium being conveyed by the conveyance part 22 (the later-described ejection port surface), ejection port arrays where multiple ejection ports for ejecting ink are arranged in arrays are formed along a direction intersecting with the X direction. The print head 24 is configured with the ability of ejecting one or multiple types of ink. In the present embodiment, the print head 24 is configured to eject black (Bk) ink, cyan (C) ink, magenta (M) ink, and yellow (Y) ink. Therefore, on the surface facing the print medium being conveyed by the conveyance part 22, the print head 24 has ejection port arrays formed for each type of ink. The discharge part 26 conveys the print medium on which printing has been performed by the print head 24 in the +Y direction and discharges the aforementioned print medium to the outside through the aperture 30 formed in the front surface 12a of the printing part 12 (see FIG. 1A and FIG. 2A).

The recovery unit 28 is placed at a position that faces the ejection port surface (the surface on which the ejection port arrays are formed) of the print head 24 located at the stand-by position. Note that the stand-by position is the position where the print head 24 is located while printing is not performed (see FIG. 3). The recovery unit 28 includes, for example, a cap part for capping and protecting the ejection port surface of the print head 24, a suction part for forcibly suctioning ink from the print head 24 with the ejection port surface in a capped state, a wiper part for wiping the ejection port surface, etc.

During printing in the printing part 12 as described above, firstly, the print medium is conveyed to the printing position by the conveyance part 22. Next, a printing operation, in which the print head 24 ejects ink while moving in the X direction, is performed on the print medium conveyed to the printing position. Thereafter, the conveyance part 22 performs a conveyance operation to convey the print medium only by a predetermined amount, and then the printing operation is performed again. In this way, the printing part 12 performs printing on the print medium by alternately and repeatedly executing the conveyance operation and the printing operation.

The operation part 16 includes, on the operation surface 16a, the display part 32 where various kinds of information are displayed and the button part 34 where various buttons for operation are installed (see FIG. 1B and FIG. 2B). As described in detail later, the operation part 16 is configured to be displaceable on the upper surface of the printing part 12 between the accommodated position where the operation surface 16a forms the upper surface of the printing part 12 and the withdrawn position where the operation part 16 is withdrawn by the user depending on the usage conditions.

The operation part 16 is located on the front side relative to the reading part 14 in the Y direction. Further, the operation part 16 is placed at a position at least partially overlapping in the X direction with the aperture 30 through which the print media after printing are discharged by the discharge part 26. Note that, in the present embodiment, the operation part 16 is installed at a position that overlaps with the aperture 30 in the X direction.

The reading part 14 is engaged with the upper surface of the printing part 12 via a pivot axis (not illustrated in the drawings), and is configured to be movable between the open position, in which the interior of the printing part 12 is open to the outside, and the closed position, in which the interior of the printing part 12 is closed, by pivotally moving about the aforementioned pivot axis. In FIG. 1B, the reading part 14 is in the open position, and in FIG. 1A, the reading part 14 is in the closed position. Note that, since various known technologies can be used for the specific configurations of the reading mechanism in the reading part 14, a detailed explanation thereof is omitted.

In a case where a jam occurs in the printing part 12, the reading part 14 is moved to the open position by being pivotally moved in the direction of arrow A (see FIG. 1A) from the closed position for removing the print medium jammed during conveyance. Accordingly, the interior of the printing part 12 is exposed to the outside through the opened part 18, thereby allowing the user to access the interior of the printing part 12 and remove the jammed print medium. Further, on the upper surface of the printing part 12, the support member 36 that supports and maintains the reading part 14 in the open position. In the printing apparatus 10, the damper unit 1202 is installed in the opening/closing mechanism of the reading part 14, which enables stable opening/closing operation of the reading part 14 (see FIG. 1B). Details of the damper unit 1202 are described later.

The printing part 12 is further equipped with the waste ink tank 302 that can store waste ink on one side (the left side) in the X direction on the front side, and the ink tank 304 that stores ink to be supplied to the print head 24 on the other side (the right side) in the X direction on the front side (see FIG. 3). In the present embodiment, the waste ink tank 302 is placed at a position partially overlapping the aperture 30 in the X direction but not overlapping the aperture 30 in the Z direction (see FIG. 2A). Further, in the present embodiment, the ink tank 304 is placed at a position not overlapping the aperture 30 in the X direction but overlapping the aperture 30 in the Z direction (see FIG. 2A).

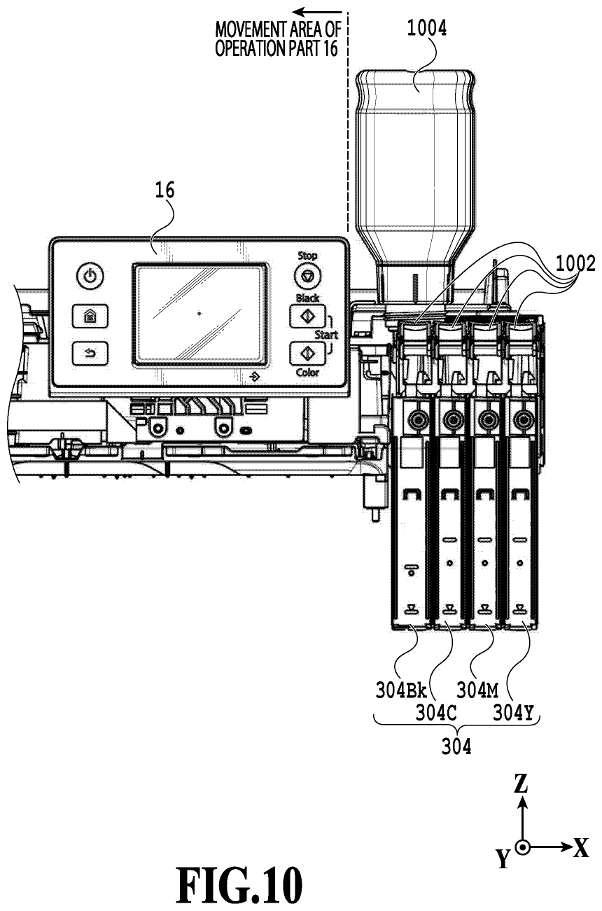

The waste ink tank 302 is connected to the recovery unit 28, so that the waste ink generated in a recovery operation performed by the recovery unit 28 is transferred from the recovery unit 28. The waste ink tank 302 is installed in the printing part 12 in a replaceable manner. Further, the ink tank 304 is connected to the print head 24, so that the ink stored therein is transferred to the print head 24. The ink tank 304 is installed in the printing part 12 in a fixed manner and is configured so that ink can be injected from the ink bottle 1004 (see FIG. 10). That is, in the present embodiment, if the amount of ink in the ink tank 304 becomes a predetermined amount or less, ink is injected from the ink bottle 1004 into the aforementioned ink tank 304 in order to replenish the ink tank 304 with ink.

The printing part 12 includes the first cover 40 that covers the upper side of the waste ink tank 302 to form the upper surface of the printing part 12, and the second cover 42 that covers the upper side of the ink tank 304 to form the upper surface of the printing part 12. The first cover 40 and the second cover 42 are placed on the front side of the printing part 12 relative to the reading part 14. Further, the first cover 40 is placed adjacent to the left side of the operation part 16, and the second cover 42 is placed adjacent to the right side of the operation part 16. In the present embodiment, the upper surface of the first cover 40, the operation surface 16a of the operation part 16, and the upper surface of the second cover 42 are approximately aligned in the Z direction (see FIG. 2A).

The printing part 12 includes the frame member 44 as a casing, in which each of the above-described constituent members is placed. Further, the reading part 14, the operation part 16, the first cover 40, and the second cover 42 are installed on the upper part of the frame member 44, so that the reading part 14, the operation part 16, the first cover 40, and the second cover 42 form the upper surface of the printing part 12. As described in detail later, the reading part 14 is installed on the frame member 44 so as to be openable and closable, while the operation part 16, the first cover 40, and the second cover 42 are installed so as to be movable with respect to the frame member 44.

The waste ink tank 302 is installed in the printing part 12 in a replaceable manner, as described above. That is, for replacing the waste ink tank 302 in the printing part 12, the first cover 40 covering the upper side of the waste ink tank 302 is moved so as to expose the waste ink tank 302 retracted in the printing part 12 to the outside, and then replacement is performed. Further, the ink tank 304 is configured so that ink can be injected from the ink bottle 1004, as described above. Therefore, for injecting ink into the ink tank 304 in the printing part 12, the second cover 42 covering the upper side of the ink tank 304 is moved so as to expose the ink tank 304 retracted in the printing part 12 to the outside, and then ink of the ink bottle 1004 is injected into the ink tank 304.

### Overview of the Operation Part, the First Cover, and the Second Cover

Next, an explanation is given about an overview of the operation part 16, the first cover 40, and the second cover 42. Note that, in the present embodiment, the operation part 16 is movable member installed in a movable manner on the frame member 44 where the printing part 12, the waste ink tank 302, and the ink tank 304 are accommodated.

### <Operation Part>

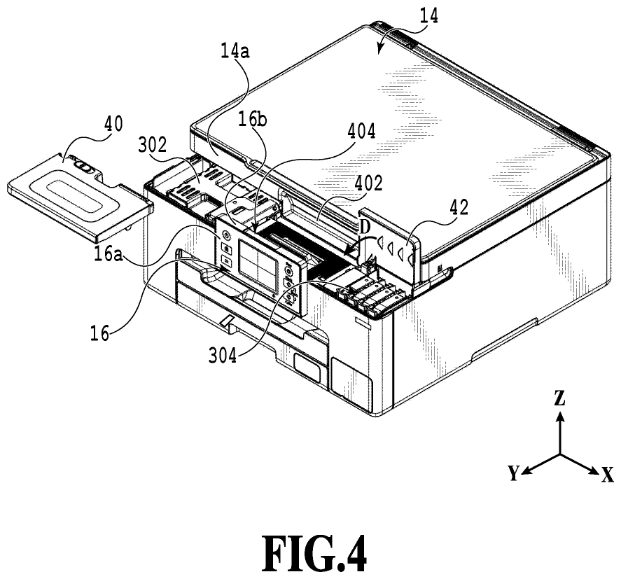

First, an explanation is given about an overview of the operation part 16. FIG. 4 is a diagram illustrating an example of the state where the operation part 16, the first cover 40, and the second cover 42 have been moved from the state of FIG. 1A.

The operation part 16 is placed so as to be revolvable via a tilt mechanism with respect to the frame member 44 of the printing part 12 in order to allow the angle of the operation surface 16a to be changed in a stepwise manner. The operation part 16 can be pivotally moved in the direction of arrow B (see FIG. 1B) from the accommodated position so as to be positioned in the withdrawn position (see FIG. 4). In this withdrawn position, the operation surface 16a is inclined with respect to the surface in contact with ground in the printing apparatus 10. This allows the user to set the operation surface 16a at an angle that is easy to view and operate, depending on the installation position of the printing apparatus 10.

As described above, the operation part 16 is located on the front side relative to the reading part 14 in the Y direction. The reading part 14 has the handhold part 402 in the side surface 14a, which faces the side surface 16b of the operation part 16 in the accommodated position while the reading part 14 is in the closed position, where the user can hook his/her hand for opening or closing the reading part 14. Note that the handhold part 402 overlaps with the operation part 16 at least partially in the X direction and Z direction. In the present embodiment, the handhold part 402 is formed in a position and length to be aligned with the operation part 16 in the X direction and formed to be longer than the operation part 16 in the Z direction (see FIG. 2A). This makes it easier for the user to hook his/her fingers on the side surface 16b of the operation part 16 for moving the operation part 16 from the accommodated position to the withdrawn position. Note that the present embodiment includes the handhold part 404 on the side surface 16b of the operation part 16, where the user can hook his/her hand for moving the operation part 16 in the accommodated position to the withdrawn position. This makes it easier to execute the job of moving the operation part 16 from the accommodated position to the withdrawn position.

### <First Cover>

Next, an explanation is given about an overview of the first cover 40. The first cover 40 is installed so as to be removable from the frame member 44. Specifically, the first cover 40 is a removable cover that can be removed from the frame member 44, thereby exposing the waste ink tank 302 to the outside, and be mounted, thereby shielding the waste ink tank 302 from the outside. Note that, as described in detail later, the first cover 40 is configured to be slid in the Y direction with respect to the frame member 44 for being attached and detached. At the time of replacing the waste ink tank 302, the first cover 40 mounted on the frame member 44 is slid and moved to the position where the first cover 40 can be removed, and then is removed from the frame member 44, so as to expose the waste ink tank 302 to the outside. Then, the user replaces the externally exposed waste ink tank 302 with, for example, a newly prepared unused waste ink tank 302. Further, after the waste ink tank 302 is replaced, the first cover 40 is placed in the position where the first cover 40 can be removed, and then slid and moved to the position where the first cover is fixed, so as to shield the waste ink tank 302 from the outside.

### <Second Cover>

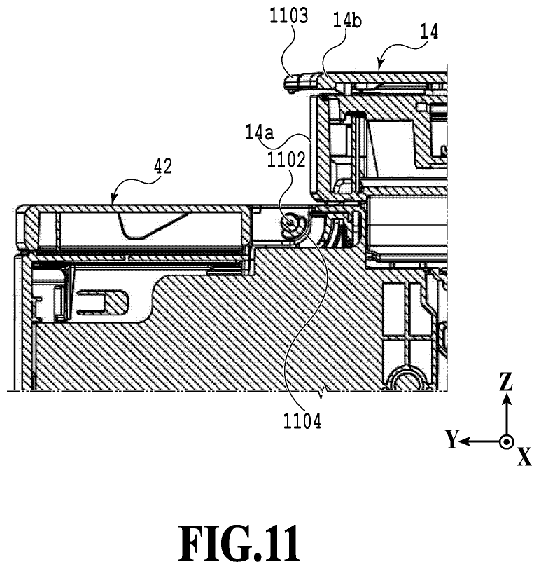

Next, an explanation is given about an overview of the second cover 42. The second cover 42 is a pivot-type cover that can pivotally move to be displaced between the open position (see FIG. 4), where the ink tank 304 is exposed to the outside, and the closed position (see FIG. 1A), where the ink tank 304 is shielded from the outside. Specifically, the second cover 42 includes the shaft member 1102 (see FIG. 11) that can be engaged with the bearing part 1104 (see FIG. 11) installed in the frame member 44, and can pivotally move about the shaft member 1102 engaged with the bearing part 1104. At the time of injecting ink into the ink tank 304, the second cover 42 in the closed position is pivotally moved in the direction of arrow C (see FIG. 1A) to expose the ink tank 304 to the outside. Then, the user injects ink from ink bottle 1004 into the externally exposed ink tank 304. Further, once the injection of ink into the ink tank 304 is completed, the second cover 42 in the open position is rotated in the direction of arrow D (see FIG. 4) to shield the ink tank 304 from the outside.

### <Relationship Between the Operation Part, the First Cover, and the Second Cover>

In this way, the printing apparatus 10 has the operation part 16, the first cover 40, and the second cover 42 placed side by side in the X direction without overlapping with one another on the front side of the upper surface of the printing part 12. This allows the printing apparatus 10 to have high visibility of the operation part 16, the waste ink tank 302, and the ink tank 304, as well as workability to the operation part 16, the waste ink tank 302, and the ink tank 304. Further, such a placement also allows jobs on the operation part 16, the waste ink tank 302, and the ink tank 304 to be executed in parallel.

Further, the placement spaces for the operation part 16, the waste ink tank 302, and the ink tank 304 do not interfere with one another. Furthermore, the operation part 16, which can be located in a relatively small space, is placed in the central part where the aperture 30, through which print media after printing are discharged, is located with respect to the X direction. Moreover, the waste ink tank 302 and the ink tank 304, which require relatively large space, are placed on the left side and the right side of the operation part 16 with respect to the X direction.

This allows the printing apparatus 10, in which multiple members are installed side by side in the X direction, to secure a wider space for placing the multiple members, compared to known technologies in which multiple members are installed in positions overlapping in the X direction and Y direction. Therefore, it is possible to expand the functions of the operation part 16, the waste ink tank 302, and the ink tank 304 by installing a movement mechanism in the operation part 16 or increasing the tank capacity, for example. Note that, by making the first cover 40 and the second cover 42 transparent or translucent, respectively, the user can view the members covered with each cover.

### Detailed Configurations of the Operation Part

Next, a detailed explanation is given about the movement mechanism of the operation part 16. As described above, the operation part 16 is placed on the frame member 44 via the tilt mechanism, and configured to be movable between the accommodated position and the withdrawn position by pivotally moving via this tilt mechanism. In the accommodated position, the operation surface 16a of the operation part 16 is approximately parallel to the surface in contact with ground in the printing apparatus 10, and in the withdrawn position, the operation surface 16a is inclined with respect to the surface in contact with ground. In the present embodiment, the withdrawn position includes the first withdrawn position with a small inclination to the surface in contact with ground and the second withdrawn position with a large inclination to the surface in contact with ground. Note that the withdrawn position is not limited to have the two positions, but may be set to have three or more positions with different inclination angles to the surface in contact with ground. Further, in the present embodiment, the tilt mechanism is used to change the position of the operation part 16 in a stepwise manner, but there is no limitation as such. That is, the operation part 16 may be placed on the frame member 44 via a movement mechanism that changes the position of the operation part 16 in a continuous manner.

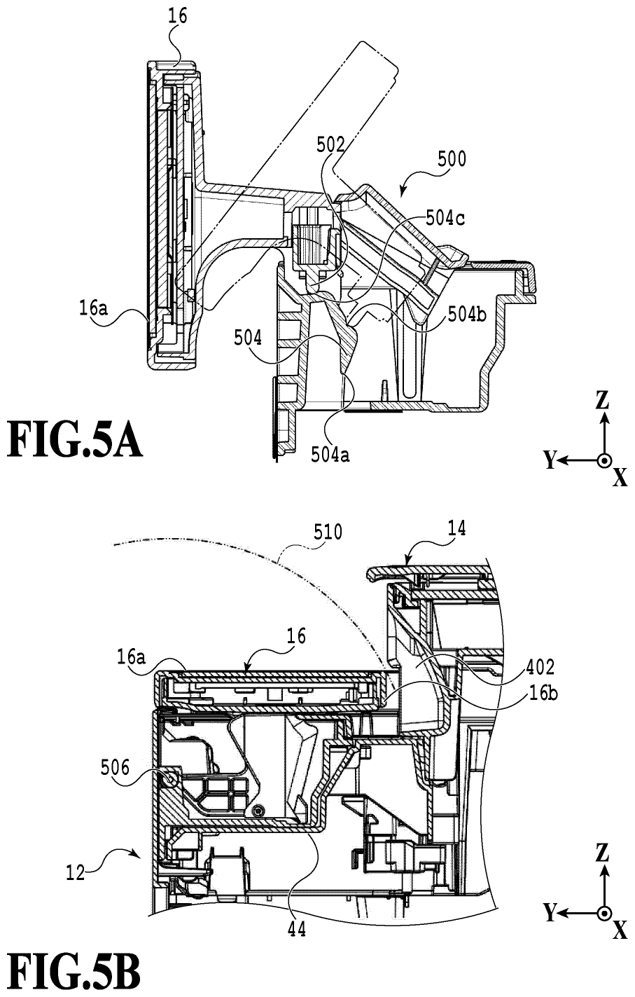

FIG. 5A and Fig. SB are cross-sectional views of an area in the vicinity of the operation part 16. Further, FIG. 5A illustrates a cross-section of the operation part 16 and a part of its tilt mechanism, which is a movement mechanism, at the time the operation part 16 is in the withdrawn position, and FIG. 5B illustrates the cross-section at the time the operation part 16 is in the accommodated position (the cross-section at the VB-VB line of FIG. 1A).

The tilt mechanism 500 includes the slider part 502 installed in the operation part 16 in a fixed manner and the cam part 504 on which the slider part 502 can slide (see FIG. 5A). The cam part 504 bas multiple stationary points at which the slider part 502 rests. That is, in the tilt mechanism 500, the slider part 502 rests at a stationary point to change the posture of the operation part 16 installed in a fixed manner with the slider part 502. Specifically, the inclination angle of the operation surface 16a with respect to the surface in contact with ground in the printing apparatus 10 is changed.

In the present embodiment, the cam part 504 is equipped with the three stationary points 504a, 504b, and 504c. In a case where the slider part 502 is positioned at the stationary point 504a, the operation part 16 is in the accommodated position. In a case where the slider part 502 is positioned at the stationary point 504b, the operation part 16 is in the first withdrawn position (see the dash-double-dot line in FIG. 5A). In a case where the slider part 502 is positioned at the stationary point 504c, the operation part 16 is in the second withdrawn position (see FIG. 5A). Note that, in the second withdrawn position, the operation part 16 does not overlap with the aperture 30 with respect to the Z direction.

The slider part 502 is configured to be biased to the cam part 504 by a biasing member (not illustrated in the drawings) so as to generate a frictional force at the contact portion between the slider part 502 and the cam part 504. This reduces unintentional movement of the operation part 16 since a load is applied to the slider part 502 at the time the slider part 502 moves on the cam part 504 and thus the operation part 16 moves only in a case where a certain amount of pressing force or more is applied from each position. Note that the operation part 16 and the tilt mechanism 500 are designed so as not to overlap with the aperture 30 in the Z direction at any position displaced by the movement. This prevents the discharge operation of the print media after printing from being disturbed.

Since the operation part 16 in the accommodated position has the operation surface 16a facing upward, dust and dirt can easily pool on the operation surface 16a. For this reason, in the present embodiment, the display part 32 may be formed as a resistive touchscreen, or the display part 32, the button part 34 which is a mechanical key, and a cover portion of the operation surface 16a may be formed in the same plane, for example. Further, a full flat configuration with a sheet key covering the front surface of the display part 32, the button part 34, and the cover portion is also possible. This makes it possible to clean the operation surface 16a without impairing the functions of the operation part 16. Note that the display part 32 is not limited to a resistive touchscreen, and various known touchscreens, such as an electrostatic touchscreen, can be applied.

The tilt mechanism 500 is configured to be revolvable about the rotary axis 506 installed in the frame member 44 (see FIG. 5B). Therefore, in the present embodiment, the operation part 16 pivotally moves about the rotary axis 506 via the tilt mechanism 500. The operation part 16 is configured so that the side surface 16b passes through the locus 510 (see the dash-double-dot line in FIG. 5B) during movement via the tilt mechanism 500. This allows the operation part 16 to be moved and withdrawn without contacting the reading part 14 even in a case where the reading part 14 is in the closed position.

### Detailed Configuration of the First Cover

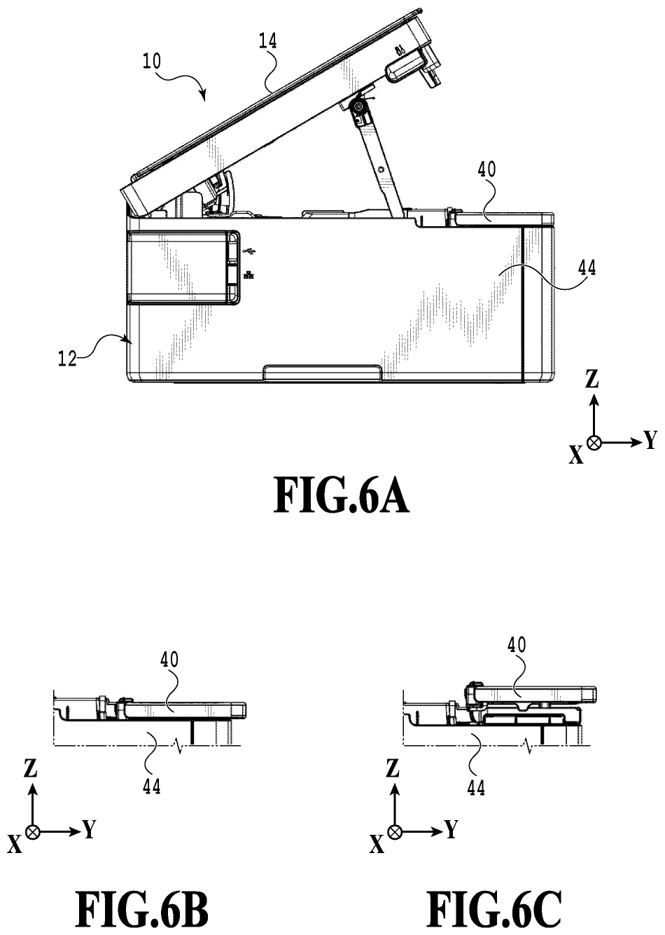

Next, a detailed explanation is given about the configuration of the first cover 40. FIG. 6A to FIG. 6C are diagrams for explaining the attachment and detachment of the first cover 40. FIG. 6A is a left side view of the printing apparatus 10 with the first cover 40 in the fixing position where the first cover 40 can be fixed to the frame member 44. FIG. 6B is an enlarged side view of an area in the vicinity of the first cover 40 in the removal position where the first cover 40 can be removed from the frame member 44. FIG. 6C is an enlarged side view of an area in the vicinity of the first cover 40 removed from the frame member 44.

As described above, the first cover 40 is configured to be slid and moved in the Y direction for being attached to or detached from the frame member 44. At the time of removing the first cover 40 from the frame member 44, the first cover 40 is slid in the +Y direction from the fixing position to be moved to the removal position (see FIG. 6B). Then, the first cover 40 is removed from the frame member 44 by moving the first cover 40 in the +Z direction from the removal position (see FIG. 6C). Further, at the time of mounting the first cover 40 onto the frame member 44, the first cover 40 is moved in the −Z direction from the upper side of the removal position so that the first cover 40 is positioned in the removal position (see FIG. 6B). Then, the first cover 40 is slid in the −Y direction from the removal position to be moved to the fixing position (see FIG. 6A). Note that, at the time the first cover 40 is attached or detached, the reading part 14 is located in the open position.

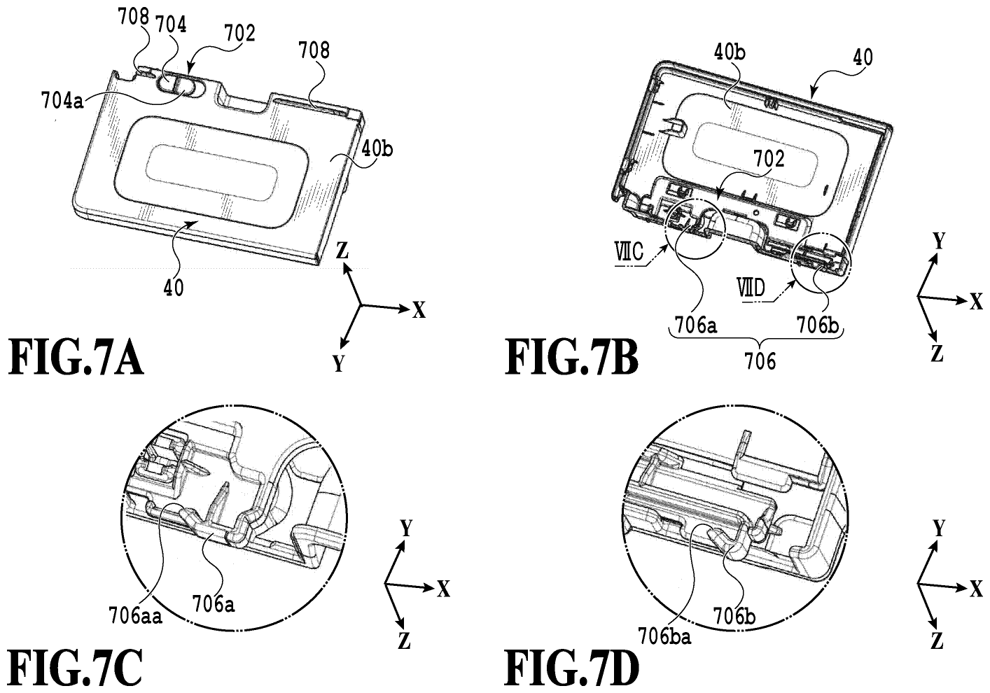

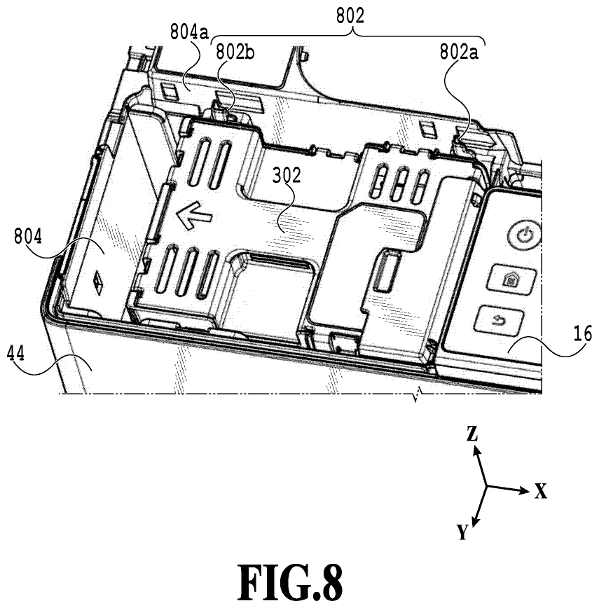

Further, the printing apparatus 10 includes a lock mechanism that fixes the first cover 40 in the fixing position to the frame member 44 with respect to the Y direction. FIG. 7A to FIG. 7D are diagrams for explaining a lock part in the lock mechanism. Further, FIG. 7A is a perspective view of the upper surface of the first cover 40, FIG. 7B is a perspective view of the bottom surface of the first cover 40, FIG. 7C is a partially enlarged view in the VIIC frame of FIG. 7B, and FIG. 7D is a partially enlarged view in the VIID frame of FIG. 7B. FIG. 8 is a diagram for explaining a retaining part in the lock mechanism. Note that the direction indicated in FIG. 7A to FIG. 7D is the direction in which the first cover 40 is attached to the printing apparatus 10.

The printing apparatus 10 includes the lock part 702 (see FIG. 7A and FIG. 7B) installed on the first cover 40 as a lock mechanism to fix the first cover 40 in the fixing position to the frame member 44 with respect to the Y direction. Further, the printing apparatus 10 includes the retaining part 802 (see FIG. 8) installed on the frame member 44 so that the lock part 702 can be retained. In the present embodiment, the lock part 702 is a lock member that can be retained on the retaining part 802.

The lock part 702 includes the user-operable lock lever 704 and the claw part 706 that can be retained on the retaining part 802 installed on the frame member 44. The lock lever 704 is installed on the upper surface 40a of the first cover 40 on one side of the Y direction, i.e., in the vicinity of the back-side end, so as to be capable of sliding in the X direction. The claw part 706 is installed on the bottom surface 40b of the first cover 40 in the vicinity of the back-side end, so as to be capable of sliding in the X direction in synchronization with the lock lever 704. The claw part 706 includes the claw part 706a and the claw part 706b, and the claw part 706a and the claw part 706b are installed at positions differing from each other in the X direction.

The retaining part 802 is installed in a position and shape capable retaining the claw part 706 of the first cover 40 in the fixing position at the back surface 804a of the accommodation part 804, which is formed by the frame member 44 to accommodate the waste ink tank 302. The retaining part 802 includes the retaining part 802a capable of retaining the claw part 706a, and the retaining part 802b capable of retaining the claw part 706b.

In a case where the lock lever 704 is in the locked position, the claw part 706 and the retaining part 802 are retained and locked. Note that the locked position is the position illustrated in FIG. 7A, and in the present embodiment, the locked position is on the left side of the later-described released position. In the fixing position, the first cover 40 is locked with the claw part 706 being retained on the retaining part 802, so that its movement in the Y direction with respect to the frame member 44 is regulated. Thus, in the present embodiment, the lock part 702 and the retaining part 802 function as a regulation part that regulates the movement of the first cover 40 in the Y direction with respect to the frame member 44.

Further, in a case where the lock lever 704 is in the released position, the claw part 706 retained on the retaining part 802 is released, so that the lock is released. Thus, the released position is the position where the claw part 706 retained on the retaining part 802 is released and the first cover 40 fixed to the frame member 44 by the lock mechanism is released. The first cover 40 in the fixing position is allowed to move in the Y direction with respect to the frame member 44 if the lock is released by releasing the claw part 706 retained on the retaining part 802.

Note that, in the fixing position, the movement of the first cover 40 in the X direction and Z direction is regulated by a configuration that allows the sliding between the removal position and fixing position (a slide guide and slide rail not illustrated in the drawings) and a configuration such as an engagement part (not illustrated in the drawings). Therefore, in the first cover 40 of the present embodiment in the fixing position, if the lock lever 704 is moved to the locked position, the movement of the first cover 40 in the X direction, Y direction, and Z direction with respect to the frame member 44 is thereby regulated, allowing the first cover 40 to be fixed.

The claw parts 706a and 706b are shaped so that the vicinities of the leading end parts 706aa and 706ba are gradually inclined in the +Y direction toward the leading end parts 706aa and 706ba. Therefore, even in a case where the lock lever 704 is not completely positioned in the released position at the time the first cover 40 is slid from the removal position to the fixing position, the claw part 706 is moved in the +X direction by the retaining part 802 as the first cover 40 moves in the −Y direction. With this configuration, it is possible to slide the first cover 40 to the fixing position even in a case where the lock lever 704 is not completely positioned in the released position at the time the first cover 40 is moved from the removal position to the fixing position.

At the time of mounting the first cover 40 onto the frame member 44, firstly, the reading part 14 in the closed position is moved to the open position. Note that, in a case where the reading part 14 is already in the open position, this process is omitted. Next, the first cover 40 is placed in the removal position, then the first cover 40 is slid from the removal position to the fixing position, and then the lock lever 704 in the released position is moved to the locked position. Accordingly, the lock part 702 (the claw part 706) is retained on the retaining part 802, thereby regulating the movement of the first cover 40 in the Y direction. Then, the reading part 14 in the open position is moved to the closed position.

Further, at the time of removing the first cover 40 from the frame member 44, the reading part 14 in the closed position is moved to the open position. Next, in the first cover 40 in the fixing position, the lock lever 704 in the locked position is moved to the released position. Accordingly, the lock part 702 (the claw part 706) retained on the retaining part 802 is released, thereby allowing the first cover 40 to move in the Y direction. Then, the first cover 40 is slid from the fixing position to the removal position, and the first cover 40 is removed from the frame member 44 at the removal position. Furthermore, if necessary, the reading part 14 in the open position is moved to the closed position.

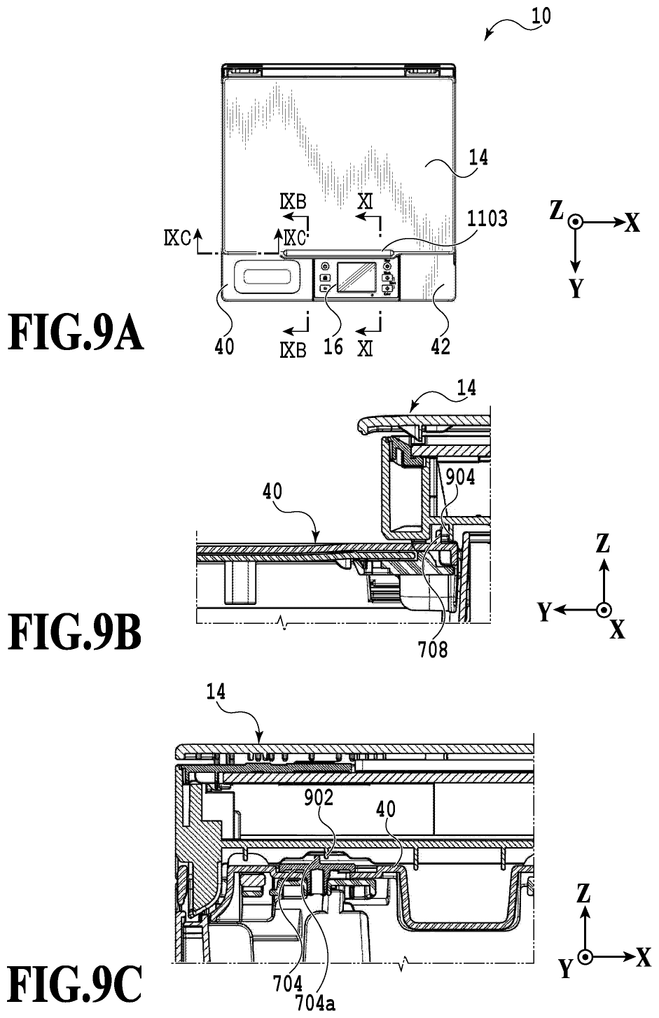

Hereinafter, an explanation is given about the relationship between the first cover 40 in the fixing position and the reading part 14 in the closed position. FIG. 9A to FIG. 9C are diagrams illustrating the relationship between the first cover 40 in the fixing position and the reading part 14 in the closed position. Further, FIG. 9A is a plan view of the printing apparatus 10, FIG. 9B is a cross-sectional view of the IXB-IXB line in FIG. 9A, and FIG. 9C is a cross-sectional view of the IXC-IXC line in FIG. 9A.

As for the first cover 40 in the fixing position, the area in the vicinity of the back-side end including the lock lever 704 overlaps in the XY plane with the reading part 14 in the closed position (see FIG. 9A). Note that the lock lever 704 is exposed at the time the reading part 14 is in the open position (see FIG. 1B). Therefore, in the printing apparatus 10, the lock lever 704 cannot be operated at the time the reading part 14 is in the closed position, and thus the lock by the lock part 702 is not unintentionally released.

Further, the reading part 14 has the regulation part 902 formed at a portion facing the first cover 40 in the fixing position so as to regulate the movement of the lock lever 704 in the locked position to the released position at the time the reading part 14 is in the closed position (see FIG. 9C). In the present embodiment, the lock lever 704 has the protrusion part 704a extending in the Y direction so as to protrude upward (see FIG. 7A and FIG. 9C). Therefore, the regulation part 902 is formed so as to protrude downward in a manner overlapping in the Z direction with the protrusion part 704a of the lock lever 704 in the locked position at the time the reading part 14 is in the closed position. Furthermore, at this time, the regulation part 902 is installed at a position that does not allow the lock lever 704 in the locked position to move in the X direction to the released position. In the present embodiment, the regulation part 902 is located so as to be spaced apart with respect to the X direction by a predetermined distance on the right side of the protrusion part 704a of the lock lever 704 in the locked position. The predetermined distance is, for example, the distance at which the retained state between the claw part 706 and the retaining part 802 is not released even if the lock lever 704 is moved by a predetermined distance to the right side. Thus, in the present embodiment, the protrusion part 704a and the regulation part 902 function as a regulating member capable of regulating the sliding of the lock lever 704 from the locked position to the released position.

Further, the first cover 40 includes the ribs 708 extending along the X direction in the vicinity of the back-side end of the upper surface 40a (see FIG. 7A). The ribs 708 are formed in the area where the first cover 40 in the fixing position overlaps in the XY plane with the reading part 14 in the closed position. In other words, the ribs 708 are formed on the upper surface 40a at a position facing the reading part 14 in the closed position at the time the first cover 40 is in the fixing position. Although the ribs 708 are installed at two locations so as to sandwich the lock lever 704 in the X direction in the present embodiment, it is also possible that the rib 708 is installed at either one of the locations.

The reading part 14 has the concave-shaped fitting part 904 that the ribs 708 can fit into (see FIG. 9B) at a portion facing the first cover 40 in the fixing position at the time the reading part 14 is in the closed position. The fitting part 904 is formed, for example, in the shape of a groove extending in the X direction, into which the ribs 708 can fit. Accordingly, even in a case where the reading part 14 is moved to the closed position without locking with the lock part 702 of the first cover 40 in the fixing position, the ribs 708 fit into the fitting part 904, thereby regulating the movement of the first cover 40 in the Y direction. That is, in the present embodiment, the fitting part 904 and the ribs 708 cooperate to function as a regulation part that regulates the sliding of the first cover 40 in the Y direction.

Thus, in the present embodiment, as for the first cover 40 in the fixing position, if the lock lever 704 is slid to the locked position and the reading part 14 is positioned in the closed position, the movement of the lock lever 704 in the X direction is regulated by the regulation part 902. This prevents the lock lever 704 from unintentionally moving to the released position due to vibration, shock, or the like. Further, even if the user forgets to slide the lock lever 704 to the locked position on the first cover 40 in the fixing position, as long as the reading part 14 is in the closed position, the sliding of the first cover 40 in the Y direction is regulated because the ribs 708 fit into the fitting part 904. With such a configuration described above, the printing apparatus 10 can prevent the first cover 40 in the fixing position from unintentionally falling off the frame member 44 as long as the reading part 14 is in the closed position.

The printing apparatus 10 is designed so that the movement area (the movable area) of the operation part 16 and the location of the waste ink tank 302 do not overlap with each other in the X direction. Therefore, the first cover 40, which covers the upper side of the waste ink tank 302, is placed at a position not overlapping with the movement area of the operation part 16 in the X direction. In the present embodiment, the movement area of the operation part 16 and the movement area (the sliding area) of the first cover 40 are designed so as not to overlap with each other in the X direction and Z direction.

### Configuration and Location of the Second Cover

Next, a detailed explanation is given of the configuration and location of the second cover 42. FIG. 10 is a diagram illustrating the positional relationship between the operation part 16 in the second withdrawn position and the ink tank 304. Note that, for ease of understanding, in the illustration of FIG. 10, some of the configurations around the operation part 16 and ink tank 304 are omitted. FIG. 11 is a cross-sectional diagram of the XI-XI line of FIG. 9A.

In the present embodiment, the ink tank 304 includes the ink tank 304Bk for storing Bk ink, the ink tank 304C for storing C ink, the ink tank 304M for storing M ink, and the ink tank 304Y for storing Y ink (see FIG. 10). In the printing part 12, each ink tank 304 can be accessed by moving the second cover 42 to the open position. Each ink tank 304 has an injection port (not illustrated in the drawings) that allows ink to be injected into the interior, and each injection port has the cap 1002 to inhibit ink leakage. The cap 1002 is made so that the ink stored in the attached ink tank 304 can be recognized by the user, for example.

For injecting ink into each ink tank 304, the second cover 42 in the closed position is moved to the open position, and the cap 1002 of the ink tank 304 to be the ink injection target is opened to expose the injection port. Next, the injection port is inserted into the ink bottle 1004 that contains the type of ink corresponding to the ink stored in the aforementioned ink tank 304. Accordingly, the ink contained in the ink bottle 1004 flows into the ink tank 304 via the injection port. If the injection of the ink from the ink bottle 1004 is completed, the injection port is removed from the ink bottle 1004 and the injection port is capped with the cap 1002. Then, the second cover 42 in the open position is moved to the closed position to finish the ink injection into the ink tank 304.

Note that the printing apparatus 10 is designed so that the movement area of the operation part 16 and the location of the ink tank 304 do not overlap in the X direction. Further, the movement area of the operation part 16 is also designed so as not to overlap in the X direction with the ink bottle 1004, which is located on the leftmost side and into which the injection port of the ink tank 304 is inserted (see FIG. 10). Therefore, the second cover 42, which covers the upper side of the ink tank 304, is placed at a position not overlapping with the operation part 16 and the movement area of the operation part 16 in the X direction. In the present embodiment, the movement area of the operation part 16 and the movement area (the pivotal movement area) of the second cover 42 are designed so as not to overlap with each other in the X direction and Z direction. That is, in the present embodiment, the operation part 16, the first cover 40, and the second cover 42 are designed so that their movement areas do not overlap with one another in the X direction and Z direction.

As for the second cover 42, the shaft member 1102 installed in the second cover 42 is fitted to the bearing part 1104 installed in the frame member 44 in a revolvable manner (see FIG. 11). Further, the reading part 14 includes the lid part 14b that presses the document placed on the platen glass from the upper side. In an approximately central portion on the front side of the lid part 14b, the handhold part 1103 protruding toward the front side is installed to make it easier to open and close the lid part 14b. This handhold part 1103 is installed at a position not overlapping with the second cover 42 in the X direction (see FIG. 9A). Further, the rotational center of the second cover 42, which is held by the frame member 44 in a revolvable manner, is located in the vicinity of the side surface 14a of the reading part 14 as well as on the front side relative to the side surface 14a. Thus, even if the reading part 14 is in the closed position, the second cover 42 can be pivotally moved to the position where the second cover 42 is approximately perpendicular to the surface in contact with ground in the printing apparatus 10. This makes it possible to perform the job of injecting ink into the ink tank 304 without the ink bottle 1004 and the second cover 42 interfering with each other.

### Damper Unit in the Opening/closing Mechanism of the Reading Part

Next, an explanation is given about the damper unit installed in the opening/closing mechanism of the reading part 14.

### <Installation Position of the Damper Unit>

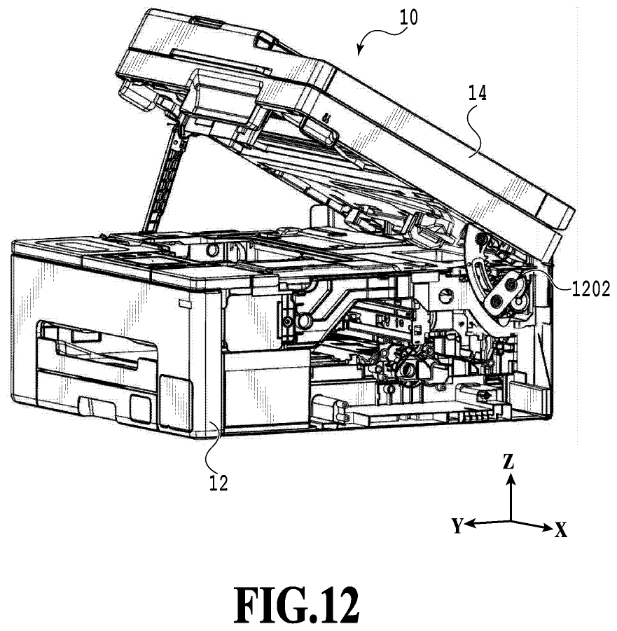

FIG. 12 is a perspective view of the printing apparatus with the reading part 14 in the open position. Note that, in FIG. 12, for ease of understanding, the right side surface of the frame member 44 is illustrated as transparent. In the printing apparatus 10, the damper unit 1202 is installed in the opening/closing mechanism of the reading part 14 to prevent the reading part 14 from moving from the open position to the closed position at high speed due to its own weight or other reasons (see FIG. 12). The damper unit 1202 is installed in the vicinity of the rotational fulcrum (not illustrated in the drawings) of the reading part 14. With the damper unit 1202 installed in the vicinity of the rotational fulcrum of the reading part 14, the amount of movement of the components of the opening/closing mechanism can be kept small, thereby making it possible to downsize the damper unit 1202.

### <Installation Structure of the Damper Unit>

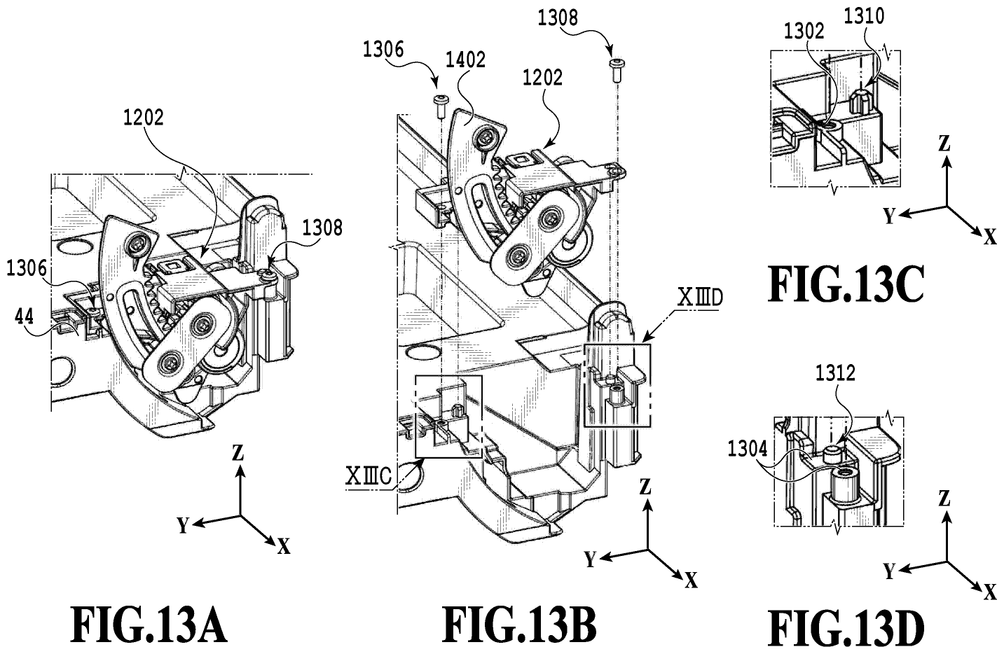

FIG. 13A to FIG. 13D are diagrams illustrating the installation structure of the damper unit 1202 on the frame member 44. FIG. 13A is a diagram illustrating the state where the damper unit 1202 is installed on the frame member 44, and FIG. 13B is a diagram illustrating the state where the damper unit 1202 and the frame member 44 separated from each other. FIG. 13C is an enlarged view of the XIIIC frame in FIG. 13B. FIG. 13D is an enlarged view of the XIIID frame in FIG. 13B.

The damper unit 1202 is fastened to the frame member 44 with the screws 1306 and 1308 in a state supported by the mounting surfaces 1302 and 1304 (see FIG. 13A to FIG. 13D). The bosses 1310 and 1312 are installed in the vicinity of the mounting surfaces 1302 and 1304 (see FIG. 13C and FIG. 13D). For fastening the damper unit 1202 to the frame member 44 with the screws 1306 and 1308, the damper unit 1202 is positioned by fitting the holes (not illustrated in the drawings) formed in the damper unit 1202 to the bosses 1310 and 1312.

The mounting surfaces 1302 and 1304 are formed so as to be approximately perpendicular to the direction of the load received by the arm gear 1402 (described later) in the damper unit 1202. Further, the frame member 44 around the mounting surfaces 1302 and 1304 is formed to have a shape and positional relationship with the surrounding members that make the frame member 44 highly rigid against the load that the damper unit 1202 receives from the reading part 14.

### <Configuration of the Damper Unit>

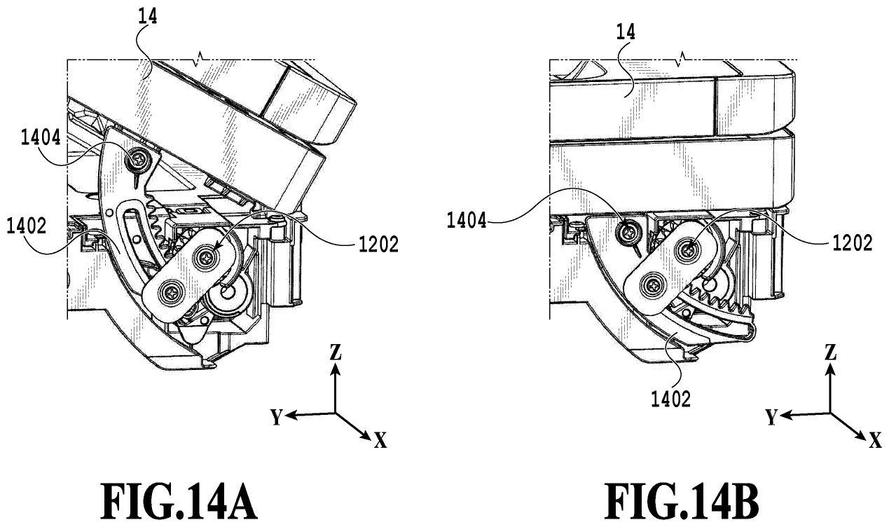

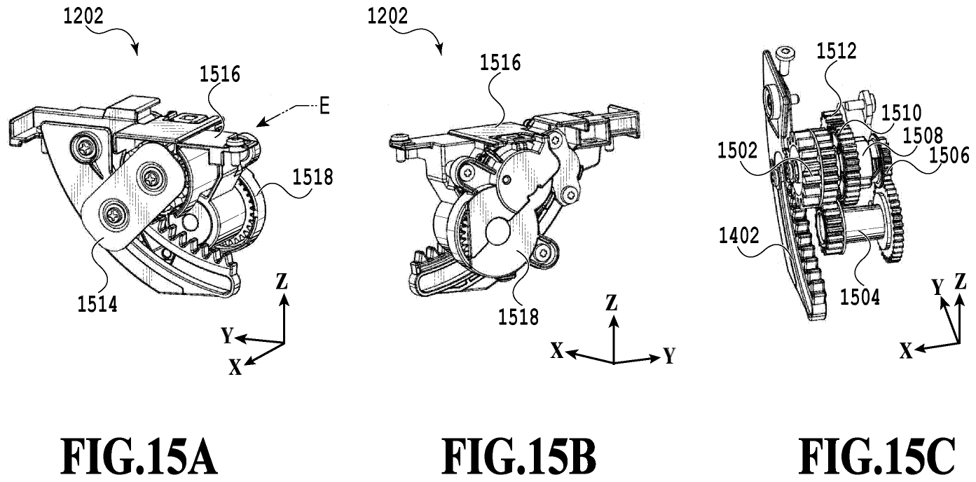

FIG. 14A and FIG. 14B are diagrams for explaining the connection of the arm gear 1402 and the reading part 14. Further, FIG. 14A is a diagram illustrating the state where the reading part 14 is in the open position, and FIG. 14B is a diagram illustrating the state where the reading part 14 is in the closed position. FIG. 15A to FIG. 15C are configuration diagrams of the damper unit 1202. Further, FIG. 15A is a perspective view, FIG. 15B is an arrow view of arrow E in FIG. 15A, and FIG. 15C is a perspective view illustrating a gear train. In FIG. 15C, the configurations other than the gear train are omitted for ease of understanding.

The reading part 14, which is installed on the frame member 44 in a revolvable manner, is connected in the vicinity of the right-side end to the arm gear 1402 of the damper unit 1202 installed on the frame member 44 (see FIG. 14A and FIG. 14B). In the present embodiment, the reading part 14 and the arm gear 1402 are fastened with the screw 1404. The damper unit 1202 is configured to generate an attenuation force at the time the reading part 14 moves in the direction from the open position toward the closed position.

In the damper unit 1202, if an external force is input from the arm gear 1402, torque is transmitted to the damper gear 1512 via the first gear 1502, the second gear 1504, the third gear 1506, the clutch 1508, and the fourth gear 1510 (see FIG. 15C). The damper gear 1512 incorporates an oil damper, which generates a predetermined attenuation torque at the time torque is input from the outside, for example. At the time the gear train operates so that the reading part 14 moves in the direction from the closed position toward the open position, the chain of drives to the damper gear 1512 is cut off by the cooperation of the clutch 1508 and the third gear 1506. This reduces the operation force required for the user to move the reading part 14 in the aforementioned direction.

The gear train in the damper unit 1202 is configured to withstand a large load input to the arm gear 1402. Specifically, each gear is supported on both sides, and the gear support parts 1514, 1516, and 1518 are configured of a material with sufficient strength (see FIG. 15A and FIG. 15B). Note that the gear support parts 1514, 1516, and 1518 may be integrally installed on the frame member 44. However, by forming the gear support parts 1514, 1516, and 1518 so as to be separated from the frame member 44 and independently configured in the damper unit 1202, the degree of freedom in material selection for the frame member 44 and gear support parts 1514, 1516, and 1518 increases. This makes it possible to use the best materials for the frame member 44 and gear support parts 1514, 1516, and 1518. Specifically, for example, a higher strength material can be used for the gear support parts 1514, 1516, and 1518, compared to the material used for the frame member 44.

### Functional Effect

As explained above, in the printing apparatus 10, the reading part 14 is placed on the back side of the upper surface of the printing part 12. Further, the operation part 16, the first cover 40 that covers the upper side of the waste ink tank 302, and the second cover 42 that covers the upper side of the ink tank 304 are placed on the front side of the aforementioned upper surface. Furthermore, the first cover 40, the operation part 16, and the second cover 42 are placed side by side in the width direction of the printing apparatus 10 so as not to interfere with one another at the time of working on the waste ink tank 302, the operation part 16, and the ink tank 304.

Accordingly, the waste ink tank 302, the operation part 16, and the ink tank 304, which are used relatively frequently in jobs executed in the printing apparatus 10, are placed at positions that makes such jobs to be easily executed and do not interfere with one another in the printing apparatus 10. Therefore, in the printing apparatus 10, compared to known technologies where an ink tank and an operation part are installed at positions overlapping in the XY plane, the installation space for each member can be larger, and a configuration that expands the functions of each member can be added. This allows the printing apparatus 10 to improve usability compared to the known technologies, while suppressing reduction in workability in using each member.

Further, the first cover 40 is formed to be capable of sliding between the fixing position where the first cover 40 can be fixed to the frame member 44 and the removal position where the first cover 40 can be removed from the frame member 44. Furthermore, as for the first cover 40 in the fixing position, a part of its area overlaps in the XY plane with the reading part 14 in the closed position. Further, the first cover 40 includes the lock part 702 for fixation to the frame member 44 in the fixing position. Moreover, the first cover 40 has the protrusion part 704a installed on the lock lever 704 that is movable between the locked position, where the first cover 40 is locked by the lock part 702, and the released position, where the lock is released. Furthermore, with the protrusion part 704a installed on the lock lever 704 and the regulation part 902 installed on the reading part 14, it is possible to regulate the lock lever 704 in the locked position from moving to the released position. Further, the first cover 40 includes the ribs 708, which can engage with the fitting part 904 installed in the reading part 14 in the fixing position, in the area overlapping with the reading part 14 in the closed position.

This prevents the first cover 40 in the fixing position from easily falling off the frame member 44 in the printing apparatus 10. Further, even without the lock by the lock part 702, the ribs 708 fit into the fitting part 904, thereby making it unlikely that the first cover 40 falls off the frame member 44.

### Other Embodiments

Note that the above-described embodiments may be modified as shown in the following (1) through (8).
(1) In the above-described embodiment, the reading part 14 is configured to read a document placed on the platen glass, but there is no limitation as such. A configuration to scan the document while conveying it by an automatic document feeder (ADF) may be used, and it is also possible to install the above-described two functions. In this case, for example, multiple types of damper units are prepared, and the most appropriate damper unit may be used according to the weight of the reading part.
(2) In the above-described embodiment, the three members, i.e., the first cover 40, the operation part 16, and the second cover 42, are arranged side by side in the width direction (the left-right direction) of the printing apparatus 10, but there is no limitation as such. At least two members out of the first cover 40, the operation part 16, and the second cover 42 may be arranged side by side in the width direction. In other words, in this case, the working areas for at least two members out of the waste ink tank 302, the operation part 16, and the ink tank 304 are arranged side by side in the width direction.
(3) In the above-described embodiment, the first cover 40, the operation part 16, and the second cover 42 are arranged side by side in the width direction of the printing apparatus 10 on the upper surface of the printing part 12 on the front side of the reading part 14, but there is no limitation as such. On the upper surface of the printing part 12, the first cover 40, the operation part 16, and the second cover 42 may be placed on the left side, or the right side, of the reading part 14. In this case, the first cover 40, the operation part 16, and the second cover 42 are arranged side by side in the depth direction (the front-back direction) of the printing apparatus 10. Furthermore, the operation part 16 is configured to be revolvable about a Z axis so that the operation part 16 can face the front, for example. Further, on the upper surface of the printing part 12, the first cover 40, the operation part 16, and the second cover 42 may be placed on the back side of the reading part 14. In this case, the first cover 40, the operation part 16, and the second cover 42 are installed side by side in the width direction of the printing apparatus 10. Furthermore, the operation part 16 is positioned on the upper side of the reading part 14 in the withdrawn position, for example.
(4) In the above-described embodiment, the printing apparatus 10 is what is termed as a serial-scan type printing apparatus that performs printing by ejecting ink, while moving the print head 24 in the X direction, onto a print medium conveyed in the Y direction, but there is no limitation as such. The printing apparatus to which the present invention can be applied may be, for example, what is termed a line-type printing apparatus, which includes a print head with an ejection port array formed in the X direction with a length corresponding to the size of the printable print medium, so as to perform printing from the fixed print head onto the print medium conveyed in the Y direction.
(5) In the above-described embodiment, the reading part 14 is placed on the back side of the upper surface of the printing part 12, and the first cover 40, operation part 16, and second cover 42 are placed along the left-right direction on the front side, but there is no limitation as such. Instead of the reading part 14, a lid part capable of opening and closing operations may be installed. In this case, the lid part is configured so as to partially overlap with an area including the lock lever 704 and the ribs 708 of the first cover 40, and a configuration corresponding to the regulation part 902 and fitting part 904 is installed at the aforementioned overlapping portion. Further, the lid part may include various known functions to be added to printing apparatuses.
(6) Although not specifically mentioned in the above-described embodiment, a sensor capable of detecting the open/closed state of the reading part 14 may be installed, so that the transfer of waste ink to the waste ink tank 302 is controlled based on detection results of the sensor.

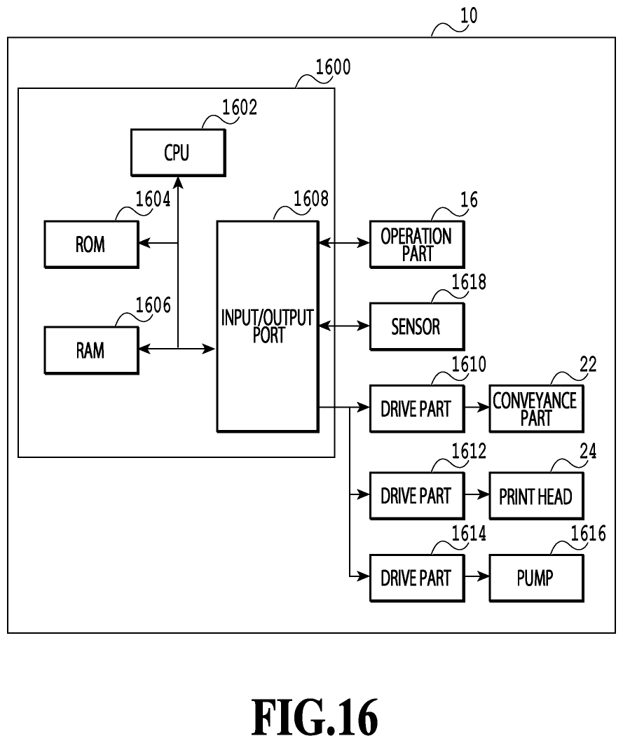

Hereinafter, an explanation is given about the configuration of the control system of the printing apparatus 10. FIG. 16 is a block diagram illustrating the configuration of the control system of the printing apparatus 10. The control part 1600 that controls the entire printing apparatus 10 includes the central processing unit (CPU) 1602, the ROM 1604, the RAM 1606, and the input/output port 1608.

The CPU 1602 performs processing operations such as calculation, selection, determination, and controlling, operational control of each constituent member of the printing apparatus 10, and image processing on input image data. The ROM 1604 stores various control and image data processing programs to be executed by CPU 1602. The RAM 1606 is utilized as a work area for the CPU 1602, etc.

The input/output port 1608 is connected to the operation part 16, and the control part 1600 controls the printing apparatus 10 based on information input from the operation part 16 via the input/output port 1608. Further, the input/output port 1608 is connected to the sensor 1618 capable of detecting the open/closed state of the reading part 14. The sensor 1618 is capable of detecting that the reading part 14 is in the open position and also that the reading part 14 is in the closed position. Since various known technologies can be used for specific detection mechanisms capable of detecting the open/closed state of the reading part 14, a detailed description thereof is omitted.

Further, the input/output port 1608 is connected to the conveyance part 22 via the drive part 1610. The control part 1600 controls the conveyance of print media by the conveyance part 22 via the drive part 1610. Furthermore, the input/output port 1608 is connected to the print head 24 via the drive part 1612. The control part 1600 controls the movement of the print head 24 in the X direction, ink ejection, etc., via the drive part 1612. In addition, the input/output port 1608 is connected via the drive part 1614 to the pump 1616 that transfers waste ink generated in the recovery unit 28 to the waste ink tank 302. The control part 1600 controls the transfer of waste ink by the pump 1616 via the drive part 1614.

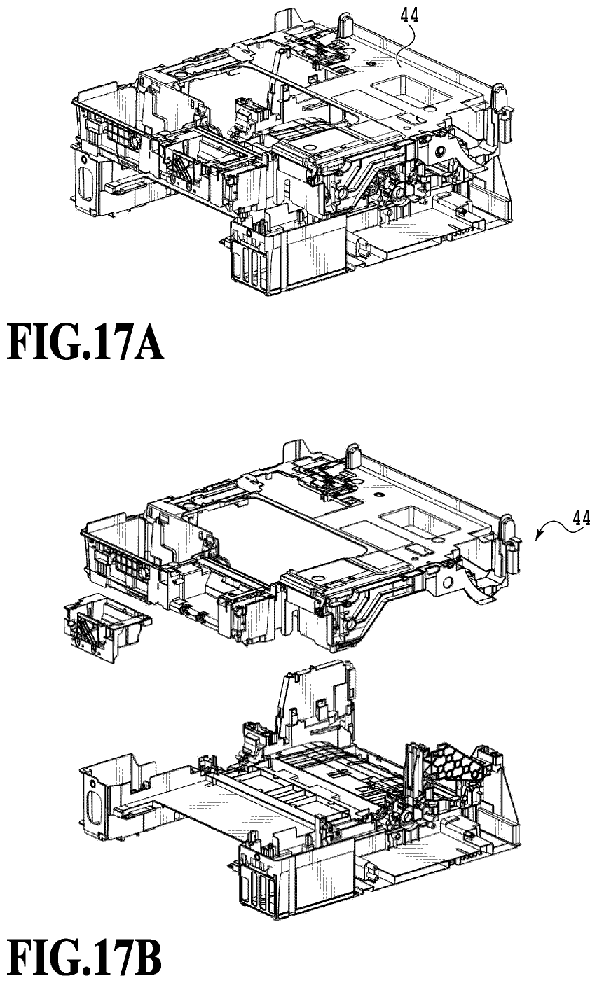

In the printing apparatus 10, if the sensor 1618 detects that the reading part 14 is in the open position while the pump 1616 is transferring waste ink to the waste ink tank 302, the control part 1600 stops driving the pump 1616 to stop transferring the waste ink. Accordingly, the movement of the reading part 14 to the open position, which is firstly executed at the time of replacing the waste ink tank 302, triggers the transfer of waste ink to be stopped, and thus the waste ink tank can be safely replaced.
(7) Although not specifically mentioned in the above-described embodiment, the frame member 44 may be configured with one member (see FIG. 17A) or with multiple members (see FIG. 17B). Further, the frame member 44 may be configured to be combined with an exterior member forming the exterior of the printing apparatus 10, or the frame member 44 may be integrally configured with the exterior member.
(8) The above-described embodiment and various forms shown in (1) through (7) may be combined as appropriate.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-137875, filed Aug. 28, 2023, which is hereby incorporated by reference wherein in its entirety.

What is claimed is:

1. A printing apparatus comprising;
a print head configured to perform printing by ejecting ink on a print medium;
a frame member configured to accommodate the print head;
an opening/closing member configured to pivotally move with respect to the frame member;
a first storing unit configured to store ink;
a first cover configured to cover the first storing unit and to be installed adjacent to side of the opening/closing member in a first direction; and
a movable member configured to move with respect to the frame member and to be installed adjacent to the side of the opening/closing member in the first direction,
wherein a part of the movable member and a part of the first cover form an upper surface of the printing apparatus together with the opening/closing member.

2. The printing apparatus according to claim 1,
wherein the movable member and the first cover have movable areas that do not overlap with one another in a second direction, which intersects with the first direction, and a third direction, which intersects with the first direction and the second direction.

3. The printing apparatus according to claim 1,
wherein the movable member and the first cover are placed side by side in a second direction, which intersects with the first direction.

4. The printing apparatus according to claim 1,
wherein the first cover is installed so as to be attachable to and detachable from the frame member.

5. The printing apparatus according to claim 1,
wherein the first cover is pivotally moved with respect to the frame member so as to be installed in an openable/closable manner with the center of its pivotal movement positioned in the vicinity of the openable/closable member in the first direction.

6. The printing apparatus according to claim 1,
wherein the movable member is installed so as to be revolvable in the frame member by changing, in a stepwise or continuous manner, an inclination angle of a surface forming the upper surface to a surface in contact with ground in the printing apparatus

7. The printing apparatus according to claim 4,
wherein the first cover is configured to be capable of sliding in the first direction between a fixing position where the first member can be fixed to the frame member and a removal position where the first member can be removed from the frame member.

8. The printing apparatus according to claim 7,
wherein the first cover has an area that overlaps with the opening/closing member in a closed position while the first member is in the fixing position.

9. The printing apparatus according to claim 8,
wherein the first cover is a cover that shields the first storing unit accommodated in the frame member in a case where the first cover is mounted on the frame member from an outside of the frame member, and that exposes the first storing unit to the outside of the frame member in a case where the first cover is removed from the frame member.

10. The printing apparatus according to claim 9,
wherein the first storing unit stores waste ink.

11. The printing apparatus according to claim 9 further comprising
a regulation unit configured to regulate the first cover in the fixing position from moving in the first direction relative to the frame member.

12. The printing apparatus according to claim 11,
wherein the regulation unit includes a lever that slides in a second direction, which intersects with the first direction, so as to regulate the movement of the first cover in the first direction relative to the frame member and to release the regulation of the movement.

13. The printing apparatus according to claim 12.
wherein the lever
is installed in the area,
is shielded from the outside of the printing apparatus in a case where the opening/closing member is in the closed position, and
is exposed to the outside of the printing apparatus in a case where the opening/closing member is in an open position.

14. The printing apparatus according to claim 12,
wherein the regulation unit includes
a lock member capable of moving in the first cover in synchronization with the sliding of the lever, and
a retaining part capable of retaining the lock member in the frame member.

15. The printing apparatus according to claim 12 further comprising:
a sensor configured to be capable of detecting an open/closed state of the opening/closing member;
a pump configured to transfer waste ink to the first storing unit; and
a control unit configured to control the driving of the pump,
wherein, if the sensor detects that the opening/closing member is in the closed position, the control unit controls the pump to stop the transfer of the waste ink.

16. The printing apparatus according to claim 12,
wherein the opening/closing member includes a regulation member, which is capable of regulating the sliding of the lever, in a portion that overlaps with the first cover in the closed position.

17. The printing apparatus according to claim 9,
wherein, in the area, the first cover includes a rib extending in a second direction, which intersects with the first direction, and
wherein the opening/closing member includes, in a portion that overlaps with the first cover in the closed position, a fitting part capable of fitting into the rib.

18. The printing apparatus according to claim 6,
wherein the movable member pivotally moves between a position in which the surface is parallel to the surface in contact with ground and a position in which the surface is approximately perpendicular to the surface in contact with ground.

19. The printing apparatus according to claim 6,
wherein the movable member is an operation unit configured to operate the printing apparatus.

20. The printing apparatus according to claim 6 further comprising
an aperture which is installed in a side surface of the frame member of the printing apparatus and through which the print medium after printing by the print head is discharged,
wherein the movable area of the movable member does not overlap with the aperture in a second direction, which intersects with the first direction.

21. The printing apparatus according to claim 5,
wherein the first cover is a cover that shields the first storing unit accommodated in the frame member in a case where the first cover is closed from an outside of the frame member, and that exposes the first storing unit to the outside of the frame member in a case where the first cover is open.

22. The printing apparatus according to claim 21,
wherein the first storing unit stores ink to be supplied to the print head.

23. The printing apparatus according to claim 22 further comprising;
a second storing unit configured to store waste ink, and
a second cover configured to cover the second storing unit and to be installed adjacent to the side of the opening/closing member in the first direction,
wherein the second cover forms the upper surface of the printing apparatus together with the opening/closing member and the first cover.

24. The printing apparatus according to claim 23,
wherein the second cover is installed so as to be attachable to and detachable from the frame member.

25. The printing apparatus according to claim 1 comprising:
an aperture through which the print medium after printing by the print head is discharged from a first surface of the printing apparatus; and
a disposing unit configured so that the print medium to be fed to the print head can be disposed,
wherein the disposing unit is installed on at least one of the side where the first surface is located and the side where a second surface, which is opposite to the first surface, is located in the printing apparatus.
